(19) United States
(12) Patent Application Publication
(10) Pub. No.: US 2019/0285151 A1
(43) Pub. Date: Sep. 19, 2019

(54) SYSTEM AND APPARATUS FOR APPLYING TORQUE

(71) Applicants: ESCO Group LLC (formerly ESCO Corporation), Portland, OR (US); Climax Portable Machining and Welding Systems, Newberg, OR (US)

(72) Inventors: David M. Paul, Corbett, OR (US); Andrew Thompson, Hendersonville, NC (US)

(21) Appl. No.: 16/370,858

(22) Filed: Mar. 29, 2019

Related U.S. Application Data
(60) Provisional application No. 62/560,933, filed on Sep. 20, 2017.

(51) Int. Cl. F16H 21/18; F16H 61/16; B25B 13/46; E02F 9/20

(52) U.S. Cl. CPC F16H 21/18; E02F 9/2079; B25B 13/467; F16H 61/16

(57) ABSTRACT

A system and apparatus for applying torque includes a power source that rotates an eccentric, which oscillates a torque head to cyclically drive a pawl into a ratchet wheel to provide torque to a component where the applied torque is greater than the received torque. The applied torque is offset from and parallel to the received torque. The torque is hydraulically powered and can be adjusted to run in both directions.

### FIELD OF THE INVENTION

The present invention pertains to a system and apparatus for applying torque.

### BACKGROUND OF THE INVENTION

In earth working operations, such as mining, ground-engaging wear parts are secured along the digging edge of a bucket of an excavating machine such as a dragline machine, cable shovel, face shovel, hydraulic excavator, and the like, to protect the digging edge from undue wear, break up the ground ahead of the digging edge and assist in gathering earthen material in the bucket. During use, the wear parts typically encounter heavy loading and highly abrasive conditions. As a result, they must be periodically replaced.

The wear part may comprise two or more components such as a base that is secured to the digging edge, and a wear member that mounts on the base to engage the ground. The wear member tends to wear out more quickly and is typically replaced a number of times before the base (which can also be a replaceable wear member) must also be repaired or replaced. One example of such a wear part is an excavating tooth. The tooth may be a two-part assembly that includes an adapter secured to the digging edge, and a point attached to the adapter to initiate contact with the ground. The tooth may also be a three-part assembly that includes a point secured to an intermediate adapter, which in turn, is secured to an adapter attached to the digging edge or to an integral nose of cast lip. Locks are used to secure the components together.

U.S. Pat. No. 9,222,243 discloses one example tooth that includes an adapter secured to the digging edge, an intermediate adapter mounted on the adapter, and a point mounted on the intermediate adapter. Locks are used to secure the point to the intermediate adapter, and the intermediate adapter to the adapter. In this example, one lock secures the point to the intermediate adapter, and two locks secure the intermediate adapter to the adapter. Each lock includes a collar that is fixed in a hole in the point or intermediate adapter, and a pin that is threaded in the collar for inward and outward adjustment between a hold position and a release position. In the hold position, the lock secures the point or intermediate adapter to its base. In the release position, the lock permits the point or intermediate adapter to be removed from and/or installed on the base.

### SUMMARY OF THE INVENTION

The present invention pertains to a system and apparatus for applying torque.

In one embodiment, a power source rotates an eccentric, which oscillates a torque head to cyclically drive a pawl into a ratchet wheel to provide torque to a component where the applied torque is greater than the received torque. In one example, the applied torque is offset from and parallel to the received torque. In one other example, the torque can be applied in both directions. In another example, the torque is hydraulically powered and/or controlled. The features of these examples are usable in combination or separately.

In another embodiment, a stop directs which of two pawls drives a ratchet wheel that provides torque to a component to determine the direction of the applied torque. In one example, a stop prevents reverse rotation of the ratchet wheel and prevents engagement of the non-driving pawl with the ratchet wheel during application of the torque. The stop is adjustable for reverse operation. In another example, the stop includes fingers to contact the ratchet wheel to prevent reverse rotation and to contact the non-driving pawl to prevent engagement with the ratchet wheel during application of the torque. The features of these examples are usable in combination or separately.

In another embodiment, hydraulic fluid to power a motor supplying torque also functions to control a stop that directs a torque enhancing mechanism to operate in either rotational direction consistent with the flow of the hydraulic fluid.

In another embodiment, a stop that directs a torque enhancing mechanism to operate in either rotational direction is hydraulically driven by a piston assembly. In one example, a shifting spool couples the stop to the piston assembly.

In another embodiment, a torque applying apparatus includes an eccentric configured to couple to a power source and having a first rotational axis, a ratchet wheel configured to couple to a rotatable component and having a second rotational axis, and a force-multiplying mechanism connecting the eccentric to the ratchet wheel. The second rotational axis is parallel to and laterally offset from the first rotational axis. The force-multiplying mechanism includes at least one pawl to incrementally drive the ratchet wheel in one direction when the pawl is moved by the eccentric.

### BRIEF DESCRIPTION OF THE DRAWINGS

FIGS. 1A and 1B are each a perspective view of a torque tool including a torque head in accordance with the present invention.

FIG. 2 is a cross-sectional view of the torque head along a central plane perpendicular to the rotation axes of the input and output portions.

FIGS. 3a-3g are each a cross-sectional view along the same plane as FIG. 2 illustrating the sequence of operation of the torque head through one cycle.

FIG. 4 is a partial cross section along a plane parallel to the view in FIG. 2.

FIG. 5 is an exploded perspective view of the torque head.

FIG. 6 is a tool head including the torque head.

FIG. 7 is a perspective view of a sample tooth.

### DETAILED DESCRIPTION OF THE PREFERRED EMBODIMENTS

The present invention pertains to a process and apparatus for applying torque. A torque applying apparatus in accordance with the present invention may be useful in adjusting locks that secure wear parts on earth working equipment, but also have application in many other and diverse uses where an enhanced torque is desired or needed.

In a mining operation, a bucket may gather earthen material during digging. The bucket includes a shell that defines a cavity for gathering material. The bucket has a lip 25 that forms a digging edge. Teeth and shrouds are often secured to the lip to protect the digging edge, break up the ground ahead of the lip, and assist in gathering earthen material into the bucket. A plurality of teeth and shrouds, such as disclosed in U.S. Pat. No. 9,222,243, which is incorporated herein by reference in its entirety, are examples of such wear parts. Tooth 27 includes an adapter 31 welded to lip 25, an intermediate adapter 33 mounted on adapter 31, and a point 35 mounted on intermediate adapter 33 (FIG. 7). Point 35 includes a rearwardly-opening cavity to receive nose 37 of intermediate adapter 33, and a front end 39 to penetrate the ground. Likewise, intermediate adapter 33 includes a rearwardly-opening cavity to receive nose 43 of adapter 31. Locks 41 are used to secure point 35 to intermediate adapter 33, and intermediate adapter 33 to of adapter 31. One lock 41a is received in the top wall 42 of point 35, and a lock 41b, 41c is received in each sidewall 44 of intermediate adapter 33. Other tooth arrangements are possible.

Lock 41 includes a collar 46 with a threaded opening, and a threaded pin 50 received in the opening. Collar 46 is fixed in a hole such as hole 52a in point 35 and holes 52b in intermediate adapter 33. Collar 46 has a pair of lugs 54, 55 that are received in complementary slots (not shown) in each of the holes in a bayonet-type coupling. Once collar 46 is in place, a retainer 58 is inserted and snap-fit into a slot (not shown) in the hole to prevent movement of the collar in the hole. Pin 50 includes a head 60 with a socket 62 for receipt of a tool to turn pin 50 in collar 46. Rotation of the pin in one direction moves the pin inward and into contact with the nose 37, 43 received in the point 35 or intermediate adapter 33. Rotation in the opposite direction moves the pin outward and out of contact with the nose to permit installation and/or removal of the point or intermediate adapter. Substantial torque is needed at times to drive the pin in the release direction as fines can become impacted in and around the threads, the pin can become bent, the threads damaged, etc.

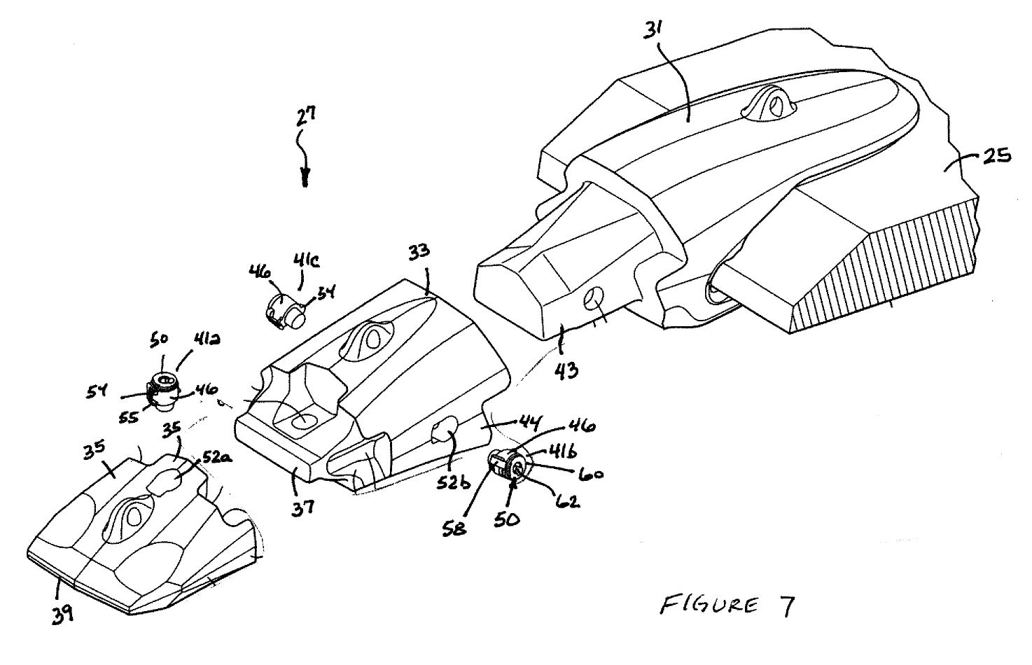

Systems have been developed to auto remove and/or install wear parts on earth working equipment such as disclosed in U.S. Patent Application 2015/0107075 and/or U.S. Patent Application 2017/0356167, which are each incorporated by reference herein in its entirety. In one embodiment, a tool head 70 connects to a manipulator (not shown) by connectors 71 (FIG. 6). A frame 72 supports a pair of gripping tools 74 and a torque tool 76. Torque tool 76 includes a motor 78, a torque applying apparatus 80 and a tool 82. The tool 82 engages socket 62 in pin 50 to adjust the pin between the hold and release positions. In one embodiment, motor 78 is a hydraulic motor but other motors could be used.

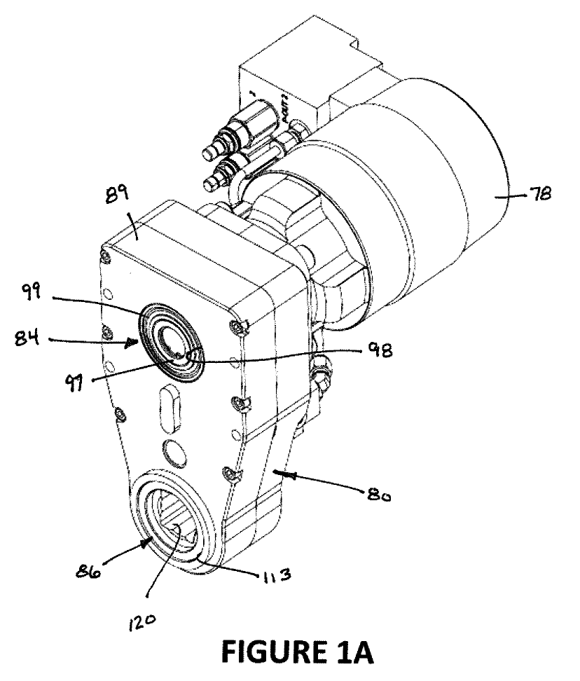

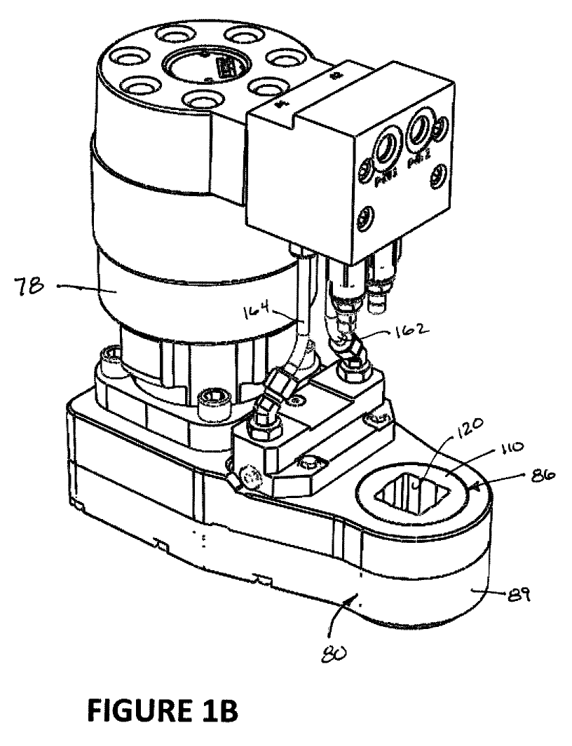

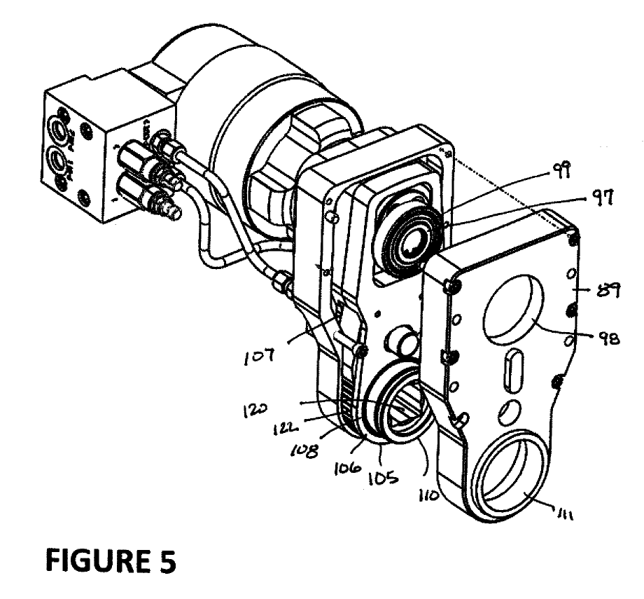

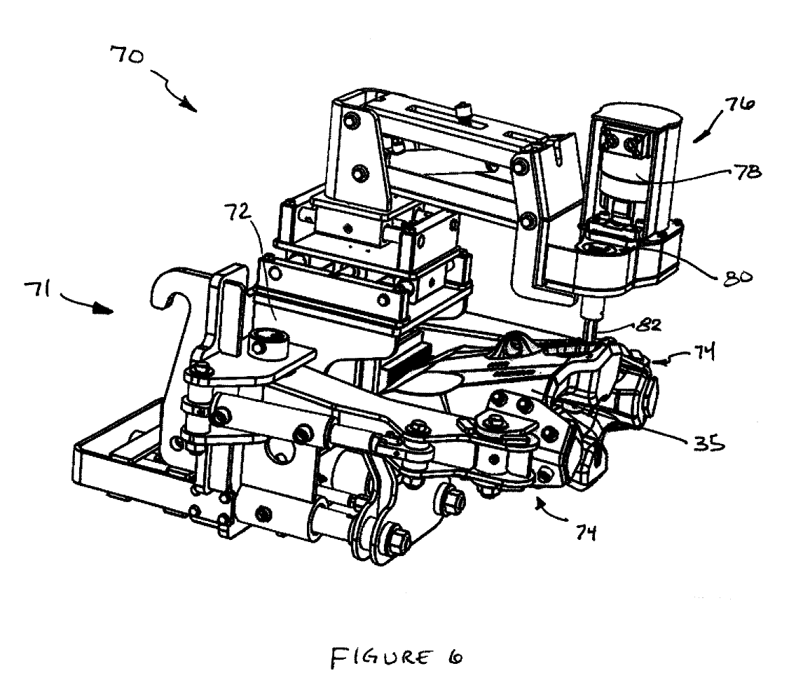

The torque applying apparatus or torque head 80 includes an input portion 84 to receive torque from a power source 78, and an output portion 86 that applies torque to a threaded or rotating component such as pin 50 (FIGS. 1A-5). The torque head 80 preferably is capable of applying torque in either direction. In the present example, the torque head can drive pin 50 to the hold position or the release position. A driving mechanism 88 couples the input portion 84 to output portion 86 to transfer and enhance the torque such that the toque applied by the output portion is greater than the torque received by the input portion. The input portion 84, output portion 86 and driving mechanism 88 are contained within a housing 89.

Input portion 84 includes an eccentric 90 received within a bearing shoe 92. The bearing shoe has a cylindrical central opening 94 into which the eccentric 90 is received for rotatable motion. An eccentrically-positioned socket 95 is formed in eccentric 90 to receive the drive shaft 96 of motor 78 to provide torque about an axis A1. In one construction, drive shaft 96 is splined for complementary receipt into slots in socket 95, though other shapes are possible. A stem 97, concentric with and extending opposite the socket 96, is received in a corresponding hole 98 in the housing 89. Bushings 99 are preferably provided between stem 97 and the wall defining hole 98. With eccentric 90 anchored by stem 97, the eccentric swings about the drive shaft as the motor rotates the drive shaft. The bearing shoe 92 is received within a channel 101 defined in a torque arm 103 of driving mechanism 88. The torque arm extends between input portion 84 and output portion 86 with a proximal end 104 containing eccentric 90 and bearing shoe 92, and a distal end 105 defined as two spaced flanges 106, 107. Each flange 106, 107 defines a hole 108 to receive a ratchet wheel 110. The housing 89 also includes holes 111, 113 to receive opposite ends of the ratchet wheel 110 to anchor the ratchet wheel and limit movement of wheel 110 to a rotation about a fixed axis A2 offset and parallel to axis A1. Accordingly, rotation of drive shaft 96 causes eccentric 90 and bearing shoe 92 to orbit about the drive shaft. The bearing shoe 92 includes sidewalls 116, 117 that bear against side surfaces 118, 119 of channel 101, and slide toward and away from output portion 86 as the eccentric 90 and bearing shoe 92 orbit about drive shaft 96. The orbiting motion of bearing shoe 92 causes the proximal end 104 of torque arm 103 to oscillate laterally within housing 89 about ratchet wheel 110 of output portion 86. Ratchet wheel 110 includes an opening 120 to receive tool 82.

Ratchet wheel 110 includes a series of ridge-like teeth 122 around its perimeter and set between flanges 106, 107. A pair of pawls 124, 125 extend from the proximal end 104 of torque arm 103, on opposite sides, toward ratchet wheel 110. The pawls each have a series of teeth 127, 128 to selectively engage teeth 122 on wheel 110. As the torque arm 103 oscillates, it drives one of the pawls 124, 125 (depending on the direction of rotation) iteratively forward and into teeth 122 to incrementally turn ratchet wheel 110 with each forward motion. A stop 130 is provided to prevent reverse motion of the ratchet wheel when the pawl resets to make another forward push. In one example, the driving mechanism 88 enhances the force from the drive shaft 96 to the tool 82 (i.e., the force applied to pin 50 or other driven member) by about 12:1, though changes to size, shape, etc. of the driving assembly components could produce other levels of enhancement.

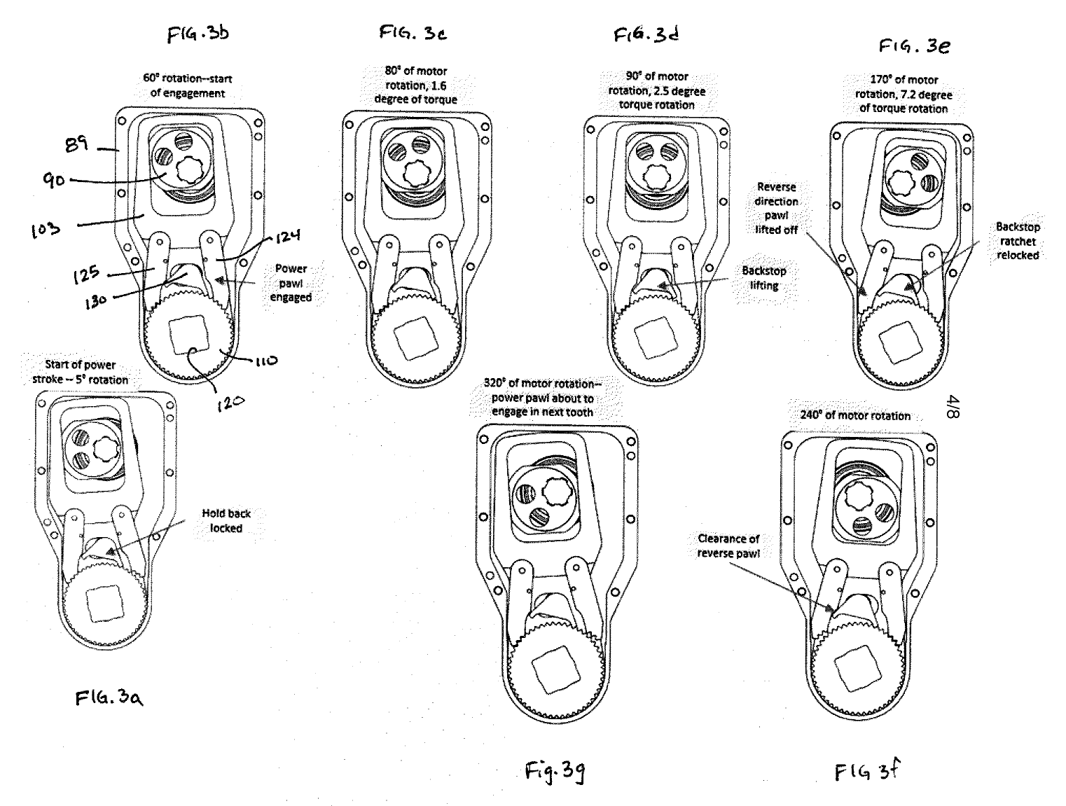

FIGS. 3a-3g illustrate the process of the driving mechanism through one cycle. FIG. 3a, shows where the first pawl 124 has pulled back for a push forward on the ratchet wheel 110. A first finger 134 of stop 130 engages a tooth 122 of ratchet wheel 110 to prevent reverse motion. As eccentric 90 reaches 60° of rotation (FIG. 3b), pawl 124 engages a new few teeth 122 for a further incremental rotation of wheel 110. A second finger 135 of cam 130 is positioned to lift the second pawl 125 from teeth 122. At 80° of eccentric rotation (FIG. 3c), pawl 124 pushes forward and moves ratchet wheel 1.6° of rotation. At 90° rotation of eccentric 90 (FIG. 3d), pawl 124 continues its forward movement to push ratchet wheel through 2.5° of rotation. At a 170° of rotation of eccentric 90 (FIG. 3e), pawl 124 has moved ratchet wheel through 7.2° of rotation whereupon first finger 134 engages a tooth 122 to prevent reverse movement of wheel 110. At 240° of rotation of eccentric 90 (FIG. 3f), pawl 124 is pulled back and disengaged from teeth 122 to, then, begin a second incremental rotation of ratchet wheel 110. At 320° of rotation of eccentric 90 (FIG. 3g), pawl 124 approaches ratchet wheel again to engage teeth 122 and rotate ratchet wheel 110. The process is the mirror image for pawl 125 to push ratchet wheel 110 in an opposite direction, i.e., when eccentric 90 is moved in the opposite direction.

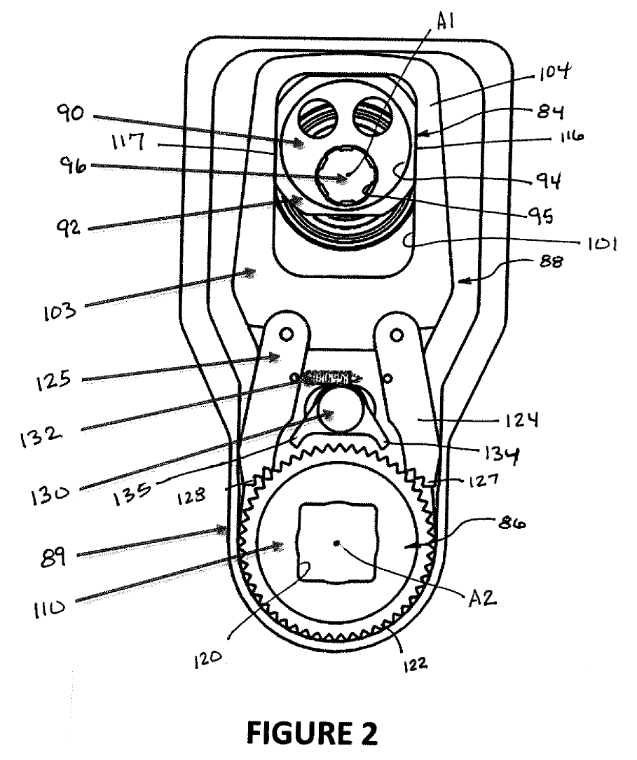

Stop 130 is adjustable between two positions; i.e., stop 130 operates to facilitate rotation of wheel 110 in one direction by pawl 124 when in a first position, and operates to facilitate rotation of wheel 110 in an opposite direction by pawl 125 when in a second position (FIGS. 2-3g). In a preferred construction, stop 130 is hydraulically adjusted between the two positions, but it could be adjusted by pneumatic, electric or otherwise arrangements. In each position, it is preferred that the stop prevent reverse motion of wheel 110 when the driving pawl is retracted, and prevent the non-driving pawl to contact wheel 110 during application of torque to pin 50 or other component. Nevertheless, these functions could be completed separately.

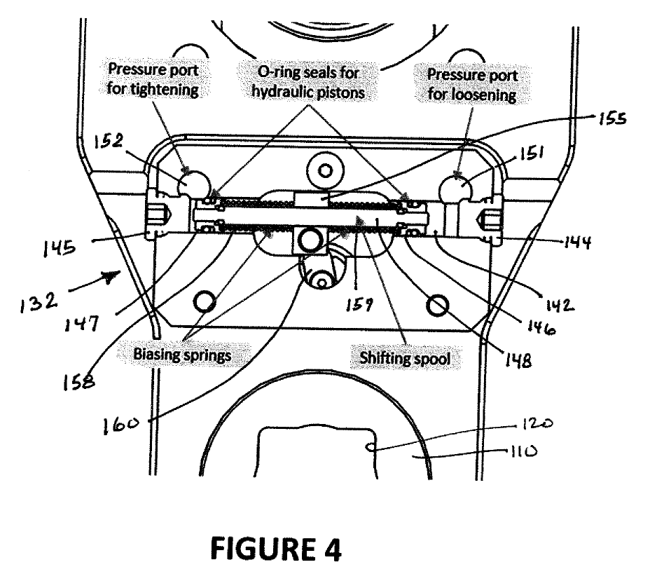

The stop 130 can be adjusted by the fluid (preferably hydraulic) driving motor 78. An adjustment assembly 132 is provided in torque head 80 to move stop 130 between its two positions (FIG. 4). In this example, adjustment assembly 132 includes a passage 142 closed on each end by a plug 144, 145. A pair of pistons 146, 147 joined by a piston rod 148 is set within the passage between plugs 144, 145. Pressure ports 151, 152 are in fluid communication with passage 142. One port 151 is coupled to passage 142 between piston 146 and plug 144, and one port 151 is coupled to passage 142 between piston 147 and plug 145. When the fluid flows in one direction it enters passage 142 through first port 151 to push piston 146 away from plug 144. The piston rod 148 then shifts piston 147 toward plug 145, and in so doing pushes fluid out of passage 142 and through port 152. When the fluid flows in the opposite direction, the piston assembly shifts in the opposite direction in passage 142. A shifting spool 155 is supported midway on piston rod 148 between the two pistons with a biasing spring 157, 158 between the spool and each piston. A lever or other connector 160 couples spool 155 and stop 130. As the pistons 146, 147 shift back and forth in passage 142, the spool 155 shifts and moves lever 160, which in turn, moves stop 130 between the two operation positions. Other adjustment assemblies could be used. The fluid run through adjustment assembly 132 is also preferably run through motor 78 such that the direction of flow is automatically consistent for a single direction of rotation for both the motor 78 and the adjustment assembly 132. Ducts 162, 164 direct fluid to adjustment assembly 132 (FIG. 1B).

With a hydraulically-driven motor 78 and stop 130, torque head 80 can be robust in varied environmental conditions, though other drives are possible for certain operations and/or conditions. A hydraulically-driven operation is less susceptible (e.g., as compared to electric drives) to failure in in-field operations where it may be subject to varied environmental conditions such as heat, cold, precipitation, dirt, fines, dust, smoke, corrosive materials, etc. A hydraulic drive is also able to provide substantial power by compact means (e.g., as compared to electric drives), which is useful for certain applications.

While the above discusses the use of torque head in replacing wear members in a mining environment, the torque head has many other and diverse applications. A torque head in accordance with the present invention may be useable to turn threaded and/or rotative members where enhanced torque is required and desired.

1. A torque applying apparatus including an eccentric configured to couple to a power source and having a first rotational axis, a ratchet wheel configured to couple to a rotatable component and having a second rotational axis, the second rotational axis being parallel to and laterally offset from the first rotational axis, and a force-multiplying mechanism connecting the eccentric to the ratchet wheel including at least one pawl to incrementally drive the ratchet wheel in one direction when the pawl is moved by the eccentric.

2. The torque applying apparatus of claim 1 wherein the force-multiplying mechanism includes a second pawl for driving the ratchet wheel in a second direction opposite to the one direction.

3. The torque applying apparatus of claim 2 including a stop for selectively preventing rotation in a reverse direction when either pawl is driving the ratchet wheel.

4. The torque applying apparatus of claim 3 wherein the stop selectively engages the non-driving pawl to prevent engagement of the non-driving pawl with the ratchet wheel.

5. The torque applying apparatus of claim 4 wherein the stop includes a first finger for engaging the ratchet wheel only when said one pawl drives the ratchet wheel in said one direction, and a second finger for engaging the ratchet wheel only when the second pawl drives the ratchet wheel in the second direction.

6. The torque applying apparatus of claim 5 wherein a hydraulically-driven adjustment assembly moves the stop between a first position where the stop prevents reverse rotation of the ratchet wheel when driven in said one direction and second position where the stop prevents reverse rotation of the ratchet wheel when driven in said second direction.

7. The torque applying apparatus of claim 6 wherein the adjustment assembly includes a hydraulically driven piston to move the stop between the first and second positions.

8. The torque applying apparatus of claim 7 including a hydraulic power source coupled to the eccentric, wherein the hydraulic fluid used to drive the power source also drives the adjustment assembly to set the stop in the first and second positions.

9. The torque applying apparatus of claim 3 wherein the stop includes a first finger for engaging the ratchet wheel only when said one pawl drives the ratchet wheel in said one direction, and a second finger for engaging the ratchet wheel only when the second pawl drives the ratchet wheel in the second direction.

10. The torque applying apparatus of claim 3 wherein a hydraulically-driven adjustment assembly moves the stop between a first position where the stop prevents reverse rotation of the ratchet wheel when driven in said one direction and second position where the stop prevents reverse rotation of the ratchet wheel when driven in said second direction.

11. The torque applying apparatus of claim 3 including a hydraulic power source coupled to the eccentric, wherein the hydraulic fluid used to drive the power source also drives an adjustment assembly to set the stop in the first and second positions.

12. The torque applying apparatus of claim 1 wherein the force multiplying mechanism increases the rotational force received by the eccentric and provided to the ratchet wheel by at least 6:1.

13. The torque applying apparatus of claim 1 wherein the force multiplying mechanism increases the rotational force received by the eccentric and provided to the ratchet wheel by at least 12:1.
